(19) United States
(12) Patent Application Publication
(10) Pub. No.: US 2025/0156993 A1
(43) Pub. Date: May 15, 2025

(54) ACCELERATED FLOOD MODELING

(71) Applicant: INTERNATIONAL BUSINESS MACHINES CORPORATION, ARMONK, NY (US)

(72) Inventors: Michiaki Tatsubori, TOKYO (JP); TATSUYA ISHIKAWA, TOKYO (JP); BLAIR NICHOLAS VICTOR EDWARDS, Manchester (GB); Nikola Elvis Stoyanov, Cheshire (GB); Ophelie Meuriot, London (GB)

(21) Appl. No.: 18/388,560

(22) Filed: Nov. 10, 2023

(51) Int. Cl. G06T 3/40; G06F 30/27; G06F 111/10

(52) U.S. Cl. CPC G06T 3/4046; G06F 30/27; G06T 3/4007; G06F 2111/10

(57) ABSTRACT

An approach is provided for accelerated flood modeling. Using a down-sampling neural network, a low-resolution elevation map is generated from a high-resolution elevation map. Using a partial differential equation (PDE) model, a low-resolution water depth map is generated from the low-resolution elevation map and one or more boundary conditions. Using an up-sampling neural network, a high-resolution water depth map is generated from the low-resolution water depth map. The down-sampling and up-sampling neural networks are trained by minimizing a loss between the generated high-resolution water depth map and ground truth data generated by the PDE model using the high-resolution elevation map as direct input and without using the low-resolution elevation map.

### BACKGROUND

The present invention relates to hydrological models, and more particularly to constructing an accelerated surrogate for a flood simulator.

Hydrological models (i.e., parameterized numerical models) are cornerstones of climate impact modeling, especially in what-if analyses related to changing climate. Due to the effects of climate change, flood forecasting has become increasingly important in recent years. Flood forecasting is usually conducted by numerically solving the shallow water equations (SWEs), which are typical nonlinear partial differential equations (PDEs). Running flood models with higher resolution can provide more detailed and accurate flood predictions. Obtaining higher resolution flood predictions by solving the SWEs on finer topography can provide an understanding of detailed flood risks. High-resolution flood modeling is enabled by utilizing high-resolution input derived by remote sensing technologies such as Light Detection and Ranging (LiDAR) systems.

### SUMMARY

In one embodiment, the present invention provides a computer system that includes one or more computer processors, one or more computer readable storage media, and computer readable code stored collectively in the one or more computer readable storage media. The computer readable code includes data and instructions to cause the one or more computer processors to perform operations. The operations include generating, using a down-sampling neural network, a low-resolution elevation map from a high-resolution elevation map. The operations further include generating, using a partial differential equation (PDE) model, a low-resolution water depth map from the low-resolution elevation map and one or more boundary conditions. The operations further include generating, using an up-sampling neural network, a high-resolution water depth map from the low-resolution water depth map. The down-sampling neural network and the up-sampling neural network are trained by minimizing a loss between the generated high-resolution water depth map and ground truth data generated by the PDE model using the high-resolution elevation map as a direct input and without the PDE model using the low-resolution elevation map.

A computer program product and a method corresponding to the above-summarized computer system are also described herein.

### BRIEF DESCRIPTION OF THE DRAWINGS

FIG. 1 is a block diagram of a system for accelerated flood modeling, in accordance with embodiments of the present invention.

FIG. 2 is a block diagram of modules included in code included in the system of FIG. 1, in accordance with embodiments of the present invention.

FIG. 3 is a flowchart of a process of accelerated flood modeling, where operations of the flowchart are performed by the modules in FIG. 2, in accordance with embodiments of the present invention.

FIG. 4 is a block diagram of a deformed geospatial encoder-decoder system that implements the process of FIG. 3, in accordance with embodiments of the present invention.

FIG. 5 is a graphical depiction of a combination of accuracy and computational time provided by the system of FIG. 4, in accordance with embodiments of the present invention.

### DETAILED DESCRIPTION

### Overview

Light Detection and Ranging (LiDAR) systems provide highly fine digital elevation models (DEMs) and allow for finer modeling of flood behavior. Performing large-scale flood simulation, however, is not practically tractable in terms of computational time. For flood simulation, the trade-off between computational time and spatial resolution has been a long-standing problem. Numerical flood simulation for high-resolution results is very slow in terms of computational time. A substantial amount of expensive computational time is required to use high resolution PDE models for flood prediction. Moreover, conventional approaches that use combinations of machine learning with PDE models are limited in considering only low-resolution models and not providing high-resolution outcomes.

Embodiments of the present invention address the aforementioned unique challenges by constructing a fast surrogate for a flood simulator, which includes a novel deep learning-based geospatial encoder-decoder for flood modeling consisting of (i) down-sampling of the input with deformation for facilitating the overall accuracy, (ii) simulating flood on the deformed, down-sampled (i.e., coarser) input, and (iii) up-sampling the simulated flood to super-resolution, being aware of the deformed simulation. The accelerated flood modeling approach disclosed herein applies a combination of a down-sampling neural network and an up-sampling neural network to PDE models to provide fast, accurate, and high-resolution flood prediction results, thereby overcoming the traditional tradeoff between computational time and accuracy of PDE-based models. In one embodiment, the accelerated flood modeling approach disclosed herein (1) accelerates flood modeling up to 50 times faster than solving the equations directly on the high-resolution input; (2) results in a small degeneration in accuracy by mean square error (MSE) 0.0179 on average with an accuracy improvement of 10% over the baseline; and (3) results in an improvement over the baseline of 20% MSE on average for the 5% worst cases.

In one embodiment, machine learning techniques including deep neural networks are used to accelerate the solving of SWEs by applying accuracy-preserving coarse-graining and super-resolution including the corresponding topography representation. The coarse-graining (i.e., down-sampling) model is trained to produce solutions of down-sampled maps, which are not necessarily accurate, but facilitate the super-resolution process to generate accurate results. The super-resolution (i.e., up-sampling) model is trained to generate well-reproduced floods from the down-sampled maps, which may be deformed. Like a traditional encoder-decoder, the flood modeling approach disclosed herein brings the input into the lower dimensional latent space and then decodes it into a reconstructed output. Using an unconventional addition to a traditional encoder-decoder to form a novel encoder-decoder, the accelerated flood modeling approach disclosed herein incorporates a PDE solver in the network to generate the output. In one embodiment, the novel encoder-decoder deforms the geospatial inputs and outputs of a flood simulation at low resolution to produce accelerated flood modeling. In one embodiment, the novel encoder-decoder model solves shallow water equations faster than a conventional approach while still capturing fine details on high-resolution water depth maps, thereby providing quick flood forecasting for disaster risk management, which has increased importance due to climate change impacts.

### Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, computer readable storage media (also called “mediums”) collectively included in a set of one, or more, storage devices, and that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

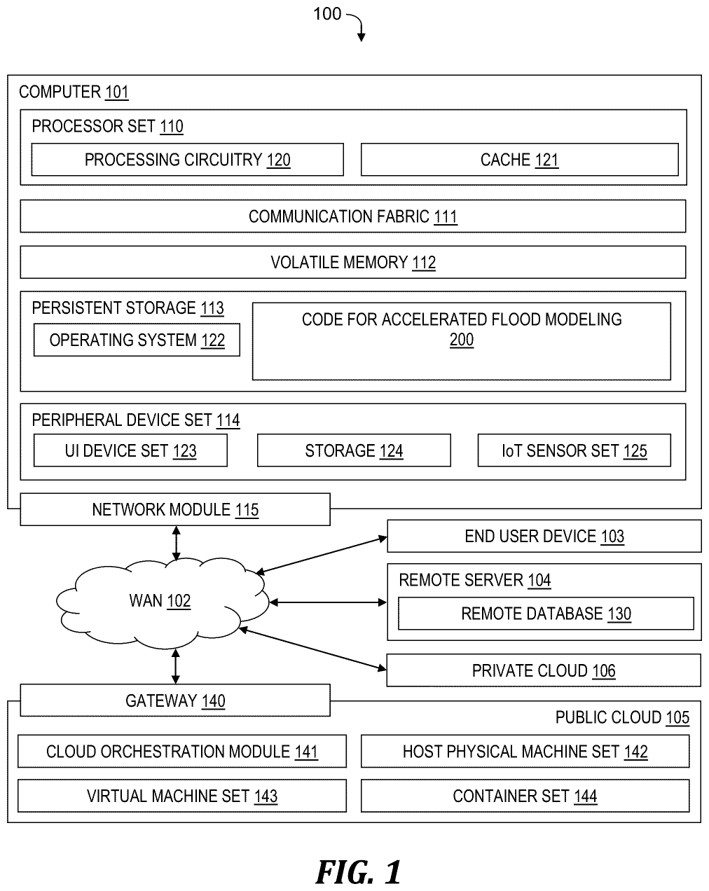

FIG. 1 is a block diagram of a system for accelerated flood modeling, in accordance with embodiments of the present invention. Computing environment 100 contains an example of an environment for the execution of at least some of the computer code involved in performing the inventive methods, such as code 200 for accelerated flood modeling. The aforementioned computer code is also referred to herein as computer readable code, computer readable program code, and machine readable code. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### System and Process for Accelerated Flood Modeling

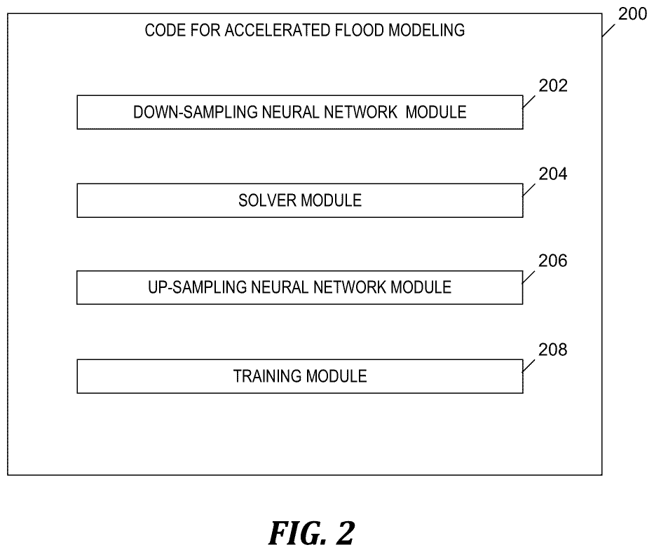

FIG. 2 is a block diagram of modules included in code 200 included in the system of FIG. 1, in accordance with embodiments of the present invention. Code 200 includes a down-sampling neural network module 202, a solver module 204, an up-sampling neural network module 206, and a training module 208.

Down-sampling neural network module 202 is configured to use a down-sampling neural network (also referred to herein as a down-sampling encoder neural network) having an input of a high-resolution elevation map to generate a low-resolution elevation map. An elevation map includes, for example, a digital elevation model (DEM). In one embodiment, the down-sampling neural network is a deep learning neural network, which employs an optimal model-order reduction based on deep learning. In one embodiment, the down-sampling neural network employs the ResNet-18 convolutional neural network. In one embodiment, the generated low-resolution elevation map provides a first representation of a topography that is physically consistent with a second representation of the topography provided by the aforementioned high-resolution elevation map.

Solver module 204 is configured to use a PDE model having an input of one or more boundary conditions and the low-resolution elevation map generated by the down-sampling neural network module 202 to generate a low-resolution water depth map (also referred to herein as a low-resolution flood map or a simulated low-resolution flood). In one embodiment, solver module 204 employs a SWE solver. As used herein, one or more boundary conditions include a combination of: (i) an amount of precipitation experienced in a geographic area during a given period of time, (ii) a rate of precipitation experienced in the geographic area during a given period of time, a temperature or a range of temperatures in the geographic area during a given period of time, (iii) an amount of wind experienced in the geographic area during a given period of time, (iv) other weather conditions experienced in the geographic area during a given period of time, (v) attribute(s) of a surface of land included in the geographic area, and (vi) an initial flood state of the geographic area. In another embodiment, the aforementioned one or more boundary conditions are replaced with one or more initial conditions. In another embodiment, the PDE model receives an input that includes the low-resolution elevation map, initial condition(s), and boundary condition(s) to generate the low-resolution water depth map.

Up-sampling neural network module 206 is configured to use an up-sampling neural network (also referred to herein as an up-sampling decoder neural network). In one embodiment, the up-sampling neural network employs the Fast Super-Resolution Convolutional Neural Network (FSRCNN) to up-sample the low-resolution water depth map to obtain the high-resolution water depth map, which provides a final high-resolution flood prediction. FSRCNN is generally used to obtain super-resolution images from low-resolution images.

Training module 208 is configured to train the down-sampling neural network and the up-sampling neural network by minimizing a loss function measuring a loss between the high-resolution water depth map generated by the up-sampling neural network module 206 and ground truth data. As used herein, ground truth data includes water depth data generated by the PDE model using high-resolution elevation maps as direct input to the PDE model, where the PDE model does not use any low-resolution elevation map as input.

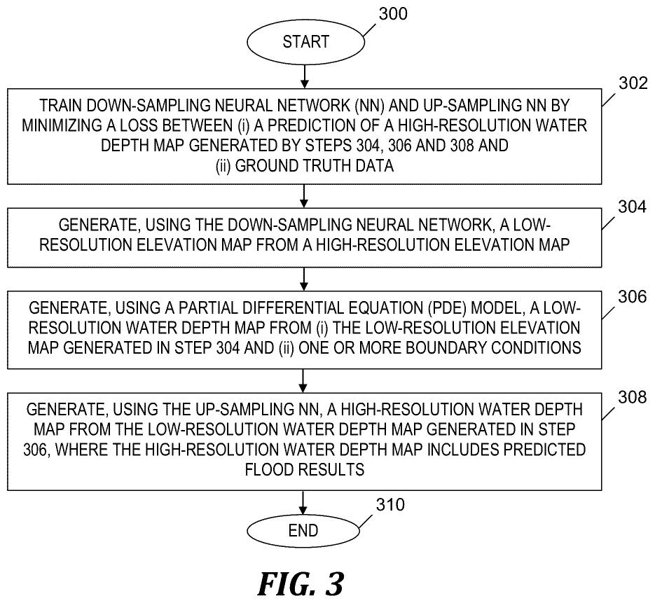

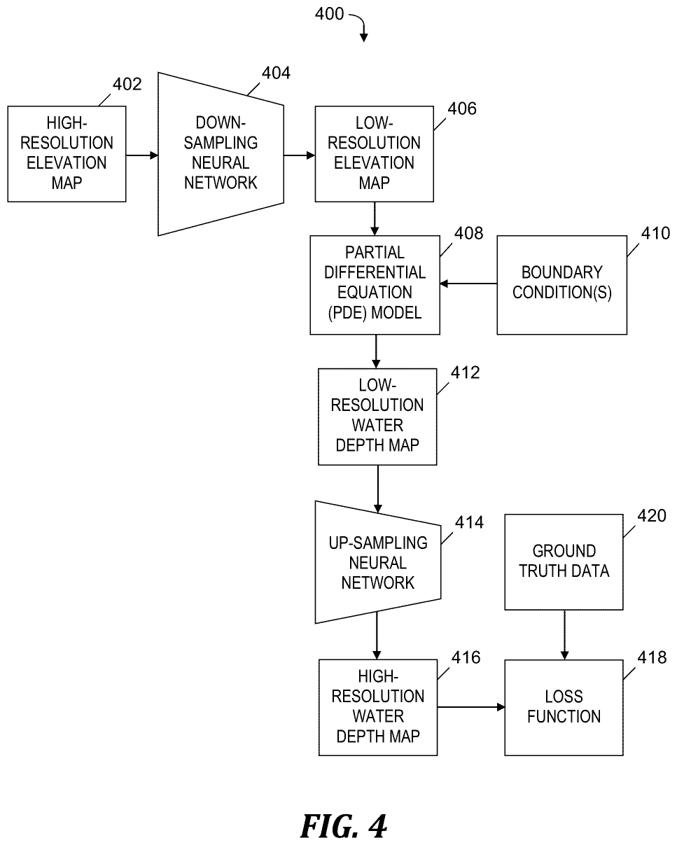

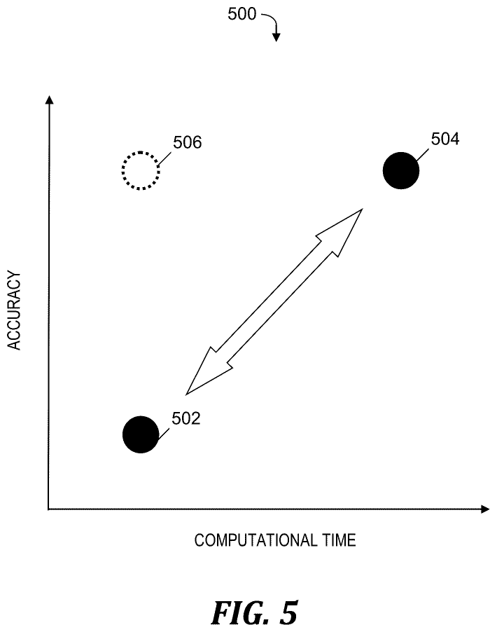

The functionality of the modules included in code 200 is described in more detail in the discussions presented below relative to FIG. 3, FIG. 4, and FIG. 5.

FIG. 3 is a flowchart of a process of accelerated flood modeling, where operations of the flowchart are performed by the modules in FIG. 2, in accordance with embodiments of the present invention. The process of FIG. 3 begins at a start node 300. A training time for the disclosed accelerated flood modeling technique is described in step 302. A prediction time for the accelerated flood modeling technique is described in steps 304, 306, and 308.

In step 302, training module 208 trains a down-sampling neural network and an up-sampling neural network by minimizing a loss function measuring a loss between (i) a high-resolution water depth map generated by steps 304, 306 and 308, as described below; and (ii) ground truth data that includes water depth data generated by a PDE model using high-resolution elevation maps as direct input to the PDE model, where the PDE model does not use any low-resolution elevation map as input (i.e., minimizing the discrepancy between the results of using high-resolution DEMs as input to the PDE model and the results of using down-sampled (i.e., coarse-grained) DEMs as input to the PDE model).

In step 304, down-sampling neural network module 202 generates a low-resolution elevation map of a geographic area from a high-resolution elevation map of the geographic area by inputting the high-resolution elevation map into a down-sampling neural network.

In step 306, solver module 204 generates a low-resolution water depth map of the geographic area from (i) the low-resolution elevation map generated in step 304 and (ii) one or more boundary conditions associated with the geographic area (e.g., a rainfall amount or rate for a given amount of time over the geographic area) by inputting the low-resolution elevation map and the one or more boundary conditions into the PDE model.

In step 308, up-sampling neural network module 206 generates a high-resolution water depth map of the geographic area from the low-resolution water depth map generated in step 306 by inputting the low-resolution water depth map into the up-sampling neural network. The high-resolution water depth map includes a prediction of flooding in the geographic area.

In one embodiment, the process of FIG. 3 includes code 200 (i) generating a temporally interpolated result by applying a temporal interpolation to the low-resolution water depth map generated in step 306; and (ii) inputting the low-resolution elevation map generated in step 304 and the temporally interpolated result into the up-sampling neural network, where generating the high-resolution water depth map in step 308 is based on the inputted low-resolution elevation map and the temporally interpolated result.

FIG. 4 is a block diagram of a deformed geospatial encoder-decoder system 400 that implements the process of FIG. 3, in accordance with embodiments of the present invention. Deformed geospatial encoder-decoder system 400 includes a high-resolution elevation map 402 of a geographic area input into a down-sampling neural network 404 (i.e., a down-sampling machine learning model), which generates a low-resolution elevation map 406 of the geographic area. A PDE model 408 in system 400 receives as input the low-resolution elevation map 406 and boundary condition(s) 410 (e.g., amount of rainfall on the geographic area over a given period of time) to generate a low-resolution water depth map 412 of the geographic area (or a portion of the geographic area).

An up-sampling neural network 414 (i.e., an up-sampling machine learning model) in system 400 receives as input the low-resolution water depth map 412 and in response to receiving the input, generates a high-resolution water depth map 416 of the geographic area (or a portion of the geographic area). In one embodiment, the up-sampling neural network 414 obtains a high-resolution flood map by applying super-resolution technique(s) to a low-resolution flood map.

The down-sampling neural network 404 and the up-sampling neural network 414 are trained by training module 208 minimizing a loss function 418 measuring a loss between ground truth data 420 and the high-resolution water depth map 416. PDE model 408 generates ground truth data 420 using high-resolution elevation maps as direct input into the PDE model 408, without using down-sampling neural network 404 or up-sampling neural network 414 (or any other machine learning model), and without using any low-resolution elevation map as input to the PDE model 408.

In one embodiment, the deformed geospatial encoder-decoder system 400 (i) generates a coarse-grained (i.e., low-resolution) PDE model of an original high-resolution model via optimal model-order reduction based on deep learning (e.g., ResNet-18 convolutional neural network); (ii) runs the coarse-grained model to obtain low-resolution, but physically consistent, results; and (iii) up-samples the low-resolution results using FSRCNN to obtain final high-resolution flood predictions.

The deformed geospatial encoder-decoder system 400 provides a light-weight physical simulation surrogate in a deformed, spatio-temporally low-resolution space. In a case with 3× low resolution (e.g., 30 m→90 m), deformed geospatial encoder-decoder system 400 can provide 27× acceleration in simulation time. In one embodiment, cascading the surrogate provides more light-weight surrogates, such as 30 m→90 m→270 m to obtain 729× acceleration in simulation time.

In one embodiment, the deformed geospatial encoder-decoder system 400 provides learning for both an input down-sample encoder and an output flood impact up-sample decoder for spatio-temporally low-resolution flood impact simulation. Given information includes the following: (i) high-resolution (HR) inputs for a HR flooding impact simulator, where the inputs include HR initial fluid state, HR geographic DEM, and HR precipitation and other geographic parameters; and (ii) spatio-temporally low-resolution (LR) flood impact simulator with a backpropagation functionality.

In one embodiment, for an arbitrarily low resolutioning rate r, where r is a natural number >1, deformed geospatial encoder-decoder system 400 trains neural networks (NNs) for down-sample encoders (i.e., r²⇒1/r²) of inputs and an up-sample decoder (i.e., 1/r²⇒r²) for fluid state outputs by: (i) giving HR inputs to the HR flood impact simulator for r steps to obtain a supervising HR flood (i.e., fluid state) result; (ii) preparing LR inputs for the LR flood impact simulator using the encoder NN (i.e., down-sampling neural network 404); (iii) running the LR flood impact simulator for a single step to obtain a simulated LR flood (i.e., fluid state) result; (iv) decoding the LR flood result to obtain a predicted HR flood result using the decoder NN (i.e., up-sampling neural network 414); and (v) computing the matching errors between the supervising HR flood result and the predicted HR flood result and to backpropagate the error gradients to optimize the weights of the NNs. In one embodiment, for arbitrary HR inputs, deformed geospatial encoder-decoder system 400 (1) runs the LR flood impact simulator using the NNs trained in the steps (i) through (v) presented above and (2) applies temporal interpolation among the obtained predicted HR flood results.

In one embodiment, for a training-time architecture for training the aforementioned encoder and decoder, a HR flood impact simulator is given HR inputs for b*r steps (where r=r_m/r_m−1) with each having d_m duration, where d_m is a time step unit in the HR flood impact simulator at the m-th layer and r_m is the relative resolution at the m-th layer. In one embodiment, for the training-time architecture and for a prediction-time architecture for generating the predicted HR flood results, the LR flood impact simulator runs for b steps with each having d_m+1 duration (where d_m+1=d_m*r).

FIG. 5 is a graph 500 depicting a combination of accuracy and computational time provided by the system of FIG. 4, in accordance with embodiments of the present invention. Graph 500 depicts the traditional tradeoff between accuracy and computational time by (i) a first point 502 indicating relatively low accuracy and relatively short computational time for flood modeling using conventional low-resolution simulation and (ii) a second point 504 indicating relatively high accuracy and relatively long computational time for flood modeling using conventional high-resolution simulation. Graph 500 also includes a point 506, which indicates a result of the accelerated flood modeling approach described herein, where the accelerated flood modeling approach provides relatively high accuracy and relatively short computational time for flood modeling having high resolution results.

The following sections describe flood simulation based on shallow water equations and describe in further detail one embodiment of the flood modeling approach provided by deformed geospatial encoder-decoder system 400.

### Shallow Water Equations

In one embodiment, SWEs are utilized by PDE model 408 to generate models for flooding in respect to topography representation. SWEs are based on mass and momentum conservation of water and are described with the three equations (1), (2), and (3) presented below:

$$\frac{\partial h}{\partial t} + \frac{\partial {q}_{x}}{\partial x} + \frac{\partial {q}_{y}}{\partial y} = 0 \qquad ( 1 )$$

$$\frac{\partial {q}_{x}}{\partial t} + gh ( \frac{\partial ( h + z )}{\partial x} ) + \frac{{gn}^{2} ‖ q ‖ {q}_{x}}{{h}^{7 / 3}} = 0 \qquad ( 2 )$$

$$\frac{\partial {q}_{y}}{\partial t} + gh ( \frac{\partial ( h + z )}{\partial y} ) + \frac{{gn}^{2} ‖ q ‖ {q}_{y}}{{h}^{7 / 3}} = 0 \qquad ( 3 )$$

where x and y are directions in Cartesian, t is the time, h is the water depth with respect to coordinates and time, qₓ and q_{y} are the flow discharges in x and y directions and denoted as q as a vector, z is the bed elevation with respect to the coordinates, g is the gravitational acceleration, and n is the Manning's friction coefficient. Boundary conditions c as q_{b} and h_{b} are also required to solve the equations.

The equations can be solved explicitly by a numerical scheme using discrete variables as proposed by Gustavo A. M. de Almeida et al. in “Improving the stability of a simple formulation of the shallow water equations for 2-D flood modeling” in Water Resources Research, volume 48, number 5, 2012. The discrete form of the elevation map and discharge are denoted as z(i, j) and q(i, j, k) respectively where i, j are the indices of the horizontal and vertical grid lines, and k is the number of time steps taken. The solver calculates a next iteration of flow discharges q (i, j, k+1) at the interface between two rectangular cells. The flow discharges from the sides of a rectangular cell are used to obtain h (i, j, k+1) at the center of the cell.

The SWE numerical solver scheme S (also referred to herein as solver, SWE solver, and PDE solver) included in PDE model 408 generates an output of h given inputs z and c and is defined as h=S(z, c). To ensure that the Courant-Friedrichs-Lewy condition is satisfied, S uses the time resolution (Δt) in equation (4) presented below.

$$Δ t = α \frac{Δ x}{\sqrt{{gh}_{max}}} \qquad ( 4 )$$

where 0<α<1 is the coefficient to reduce the time resolution, Δx is the spatial resolution from the elevation model, and h_max is the maximum water depth.

### Geospatial Encoder-Decoder

Deformed geospatial encoder-decoder system 400 combines down-sampling and super-resolution methods that accelerate high resolution flood modeling. Down-sampling the high-resolution elevation map 402 into low-resolution elevation map 406 reduces the number of grid points, which reduces the computational time of SWE numerical solver scheme S included in PDE model 408. As an additional benefit of larger spatial resolution, deformed geospatial encoder-decoder system 400 can take larger time steps as in equation (4), which further reduces the computational time. The down-sampled (i.e., coarser grain) DEM, however, introduces false topography information, thereby affecting the accuracy of the solution to the SWEs provided by SWE numerical solver scheme S. Hence, learned interpolation via the down-sampling machine learning model (i.e., down-sampling neural network 404) is utilized to correct the input of S from high-resolution elevation map 402 to low-resolution elevation map 406, then produce low-resolution water depth map 412 in two-dimensions with respect to boundary condition(s) 410. The aforementioned process that utilizes the learned interpolation is written as equation (5) presented below:

$${h}_{LR} = S ( {F}_{U} ( {z}_{HR} ) , c ) \qquad ( 5 )$$

where h_{LR} is low-resolution water depth map 412, F_{U} is down-sampling neural network 404, z_{HR} is high-resolution elevation map 402 and c is boundary condition(s) 410.

It is desirable that the outcome of the shallow water model provided by equations (1), (2) and (3) should be in high-resolution. Therefore, deformed geospatial encoder-decoder system 400 performs more detailed processing. After down-sampling the DEM (i.e., z_{HR}; also called high-resolution elevation map 402) as an input to S to generate h_{LR}, deformed geospatial encoder-decoder system 400 up-samples h_{LR} to high-resolution water depth map 416 (i.e., h_{HR}). Deformed geospatial encoder-decoder system 400 up-samples via a machine learning model F_{D} (i.e., up-sampling neural network 414), which corrects error in the high-resolution water depth and provides detailed water depth in the topography representation, whereas up-sampling that employs a traditional interpolation method such as bilinear interpolation fails to return detailed water depth in the topography representation. The whole process provided by deformed geospatial encoder-decoder system 400 is defined in equation (6) presented below:

$${h}_{HR} = {F}_{D} ( S ( {F}_{U} ( {z}_{HR} ) , c ) ) = {F}_{DU} ( {Z}_{HR} , c ) \qquad ( 6 )$$

where F_{DU} is the encoder-decoder model used by deformed geospatial encoder-decoder system 400. The aforementioned encoder-decoder model designated by F_{DU} is also referred to herein as the encoder-decoder model disclosed herein. To ensure that the encoder-decoder model F_{DU} learns, deformed geospatial encoder-decoder system 400 minimizes a loss function that measures a loss between (i) the solution from S with z_{HR} as the direct input to generate h_{HR}^{S} as the ground truth data and (ii) h_{HR} generated by the machine learning model (i.e., the encoder-decoder model). Deformed geospatial encoder-decoder system 400 updates the weights of F_{D} and F_{U} through a backpropagation mechanism following a calculation of the aforementioned loss.

The encoder-decoder model consists of down-sampling and up-sampling parts. For example, the down-sampling model uses the ResNet-18 convolutional neural network, which provides an effective machine learning model for capturing features in a coarser grain for the low-resolution elevation map 406.

For example, the up-sampling model uses FSRCNN to up-sample low-resolution water depth map 412 to high-resolution water depth map 416. FSRCNN is generally used to obtain super-resolution images from low-resolution images. FSRCNN has a small number of parameters while still providing good performance. In one embodiment, up-sampling neural network 414 uses FSRCNN while replacing the deconvolution layer with SubPixel Convolution layers as reported in Wenzhe Shi et al, “Real-time single image and video super-resolution using an efficient sub-pixel convolutional neural network,” 2016 IEEE Conference on Computer Vision and Pattern Recognition (CVPR), 2016, pages 1874-1883 to further reduce the number of parameters. In one embodiment, up-sampling neural network adds a final convolution layer to convert multiple channels into a single channel and uses batch-normalization in the up-sampling model except for the SubPixel layers and the last layer.

### Example

An experiment demonstrating acceleration provided by deformed geospatial encoder-decoder system 400 uses a dataset consisting of one-meter resolution DEM obtained from three areas near the Mississippi river and the Arkansas river. The elevation maps are tiled so each data point has 2000×2000 pixels and is normalized by subtracting its mean. There are 5183 elevation maps, with information of influx and outflux of water discharge available for each elevation map.

For the experiment, the encoder-decoder model is trained using: (1) Huber Loss as the loss function; (2) the stochastic optimization method called Adam for the optimization scheme in backpropagation; (3) a learning rate of 10⁻³; and (4) a batch size of 4 samples for 80 epochs. The solver uses α=0.7 and diffusion coefficient θ=0.7. The experiment uses a mean squared error (MSE) between static output of the encoder-decoder model and the ground truth data as a metric score for an evaluation of the model's performance. MSE is defined in equation (7) presented below:

$$MSE ( {h}_{HR} , {h}_{HR}^{S} ) = \frac{1}{MN} {\sum }_{i , j}^{M , N} {( {h}_{HR} ( i , j ) - {h}_{HR}^{S} ( i , j ) )}^{2} \qquad ( 7 )$$

where M is the maximum of the horizontal index i and N is the maximum of the vertical index j.

To show the advantage of accelerated computational time in the experiment, four models with a scaling factor s as 2, 4, 8, and 16, respectively, are prepared. The experiment evaluates the trained models on their computational time in a single GPU for one hour of simulation time. The experiment takes the average of the computation time taken to solve a single elevation map and compares the average with computational time taken by solving directly using the same high-resolution elevation map. The speedup time is defined as a time for solving directly divided by computational time taken by the encoder-decoder model.

To show the effectiveness of the encoder-decoder model in deformed geospatial encoder-decoder system 400, the experiment compares the encoder-decoder model with a straightforward fixed-weight model as a baseline model. In the baseline model (also referred to herein as Baseline), the experiment uses a simple average pooling method as F_{U} and bilinear interpolation as F_{D}. Furthermore, the experiment performs an ablation study in which a down-sampling ResNet-18 is used as F_{U}, while bilinear interpolation is used as F_{D} in a model referred to herein as BilinearNet. For the experiment, 2750 elevation maps are used. These 2750 elevation maps are randomly picked from the original 5183 maps and are further randomly split into 2250 maps for training, 250 maps for testing, and 250 maps for validation. The experiment trains the encoder-decoder model and its ablated version using two GPUs and a scaling factor s=16. The experiment assesses the performance by MSE using the final output water depth map after one hour of simulation time for each model.

In the results of the experiment, using scaling factor s=16 and a one-hour simulation on the dataset, the encoder-decoder model included in deformed geospatial encoder-decoder system 400 speeds up the computational time by 52.6 times as compared with directly solving using a high-resolution elevation map. Faster computational time is provided because the encoder-decoder model solves the SWEs in a lower resolution which reduces the number of grid points to be solved. Hence, the encoder-decoder model shows an advantage when generating high-resolution water depth maps compared with directly solving using a high-resolution elevation map.

Overall, the encoder-decoder model disclosed herein performs better than the baseline and the ablated models in generating high-resolution water depth maps according to the experimental setup. The encoder-decoder model disclosed herein improves the MSE score by 10.3% on average compared with Baseline in scaling factor s=16. Based on the Wilcoxon signed-rank test, the difference in average MSE between the encoder-decoder model disclosed herein and Baseline is statistically significant as p-value 0.05. Furthermore, the encoder-decoder model disclosed herein improves by 16.7% for the 5% quantile of worst cases and gives a 20.5% improvement of the average over Baseline. Meanwhile, the BilinearNet also improves the MSE on the 5% worst cases but improves the average of MSE only slightly. This result can be seen in Table 1 which includes MSE scores based on quantiles and the average of MSE scores among (i) Baseline, (ii) embodiments of the present invention (i.e., the encoder-decoder model included in deformed geospatial encoder-decoder system 400), and (iii) BilinearNet, where the best scores are in boldface. Table 1 includes the row label “Ave5%” to indicate the average MSE scores for the 5% worst cases and further includes the column label “% Change” to indicate the percentage change for the difference between the Baseline MSE score and the MSE score for the encoder-decoder model disclosed herein.

TABLE 1

| | | Embodiments of | | % Change |
|---|---|---|---|---|
| %-th Quantile | Baseline | Invention (EOI) | BilinearNet | (Baseline − EOI) |
| 5 | 0.00189 | 0.00261 | 0.00294 | −38.1 |
| 25 | 0.00546 | 0.00752 | 0.00664 | −37.7 |
| 50 | 0.01274 | 0.01261 | 0.01348 | 1.02 |
| 75 | 0.02394 | 0.02143 | 0.02417 | 10.5 |
| 95 | 0.06320 | 0.05267 | 0.05701 | 16.7 |
| Ave5% | 0.09633 | 0.07654 | 0.09147 | 20.5 |
| Average | 0.02001 | 0.01794 | 0.01999 | 10.3 |

The experiment performs a detailed inspection of some results selected from the 5% worst cases, which indicates that compared with Baseline and BilinearNet, the encoder-decoder model disclosed herein has fewer errors near the important features (e.g., water on the sides of trenches and the water inside a waterway itself). This result suggests that the encoder-decoder model disclosed herein effectively captures fine details of important features that affect the water depth, such as narrow trenches, while the baseline poorly generates these details of important features. It is especially important to generate water depth of these trench areas because during flooding, the immediate impact is experienced near these areas. The result indicates that applying machine learning in up-sampling is effective in capturing these fine details because the BilinearNet, which is the ablated version of the encoder-decoder model disclosed herein and provides a fixed-weight up-sampling model, poorly produces the fine details of important features.

The descriptions of the various embodiments of the present invention have been presented herein for purposes of illustration but are not intended to be exhaustive or limited to the embodiments disclosed. Many modifications and variations will be apparent to those skilled in the art. Accordingly, the appended claims are intended to encompass all such modifications and variations as fall within the true spirit and scope of the embodiments described herein.

What is claimed is:

1. A computer system comprising:
one or more computer processors;
one or more computer readable storage media; and
computer readable code stored collectively in the one or more computer readable storage media, with the computer readable code including data and instructions to cause the one or more computer processors to perform at least the following operations:
generating, using a down-sampling neural network, a low-resolution elevation map from a high-resolution elevation map;
generating, using a partial differential equation (PDE) model, a low-resolution water depth map from the low-resolution elevation map and one or more boundary conditions; and
generating, using an up-sampling neural network, a high-resolution water depth map from the low-resolution water depth map,
wherein the down-sampling neural network and the up-sampling neural network are trained by minimizing a loss between the generated high-resolution water depth map and ground truth data generated by the PDE model using the high-resolution elevation map as a direct input and without the PDE model using the low-resolution elevation map.

2. The computer system of claim 1, wherein the computer readable code including the data and the instructions causes the one or more computer processors to perform the following further operations:
determining the loss between the high-resolution water depth map and the ground truth data; and
subsequent to the determining the loss, updating weights of the down-sampling and the up-sampling neural networks through backpropagation.

3. The computer system of claim 1, wherein the computer readable code including the data and the instructions causes the one or more computer processors to perform the generating the low-resolution elevation map from the high-resolution elevation map by employing an optimal model-order reduction based on deep learning.

4. The computer system of claim 1, wherein the generated low-resolution elevation map provides a first representation of a topography that is physically consistent with a second representation of the topography provided by the high-resolution elevation map.

5. The computer system of claim 1, wherein the computer readable code including the data and the instructions causes the one or more computer processors to perform the generating the high-resolution water depth map by employing a Fast Super-Resolution Convolutional Neural Network (FSRCNN) to obtain final high-resolution flood predictions.

6. The computer system of claim 1, wherein the computer readable code including the data and the instructions causes the one or more computer processors to perform the following further operations:
generating a temporally interpolated result by applying a temporal interpolation to the low-resolution water depth map; and
inputting the low-resolution elevation map and the temporally interpolated result into the up-sampling neural network, wherein the generating the high-resolution water depth map is based on the inputted low-resolution elevation map and the temporally interpolated result.

7. The computer system of claim 1, wherein a boundary condition included in the one or more boundary conditions is selected from the group consisting of: an amount of precipitation experienced in a geographic area during a given period of time, a rate of precipitation experienced in the geographic area during the given period of time, a range of temperatures in the geographic area during the given period of time, an amount of wind experienced in the geographic area during the given period of time, other weather conditions experienced in the geographic area during the given period of time, one or more attributes of a surface of land included in the geographic area, and an initial flood state of the geographic area.

8. A computer program product comprising:
one or more computer readable storage media having computer readable program code collectively stored on the one or more computer readable storage media, the computer readable program code being executed by one or more processors of a computer system to cause the computer system to perform at least the following operations:
generating, using a down-sampling neural network, a low-resolution elevation map from a high-resolution elevation map;
generating, using a partial differential equation (PDE) model, a low-resolution water depth map from the low-resolution elevation map and one or more boundary conditions; and
generating, using an up-sampling neural network, a high-resolution water depth map from the low-resolution water depth map,
wherein the down-sampling neural network and the up-sampling neural network are trained by minimizing a loss between the generated high-resolution water depth map and ground truth data generated by the PDE model using the high-resolution elevation map as a direct input and without the PDE model using the low-resolution elevation map.

9. The computer program product of claim 8, wherein the computer readable program code being executed by the one or more processors of the computer system causes the computer system to perform the following further operations:
determining the loss between the high-resolution water depth map and the ground truth data; and
subsequent to the determining the loss, updating weights of the down-sampling and the up-sampling neural networks through backpropagation.

10. The computer program product of claim 8, wherein the computer readable program code being executed by the one or more processors of the computer system causes the computer system to perform the generating the low-resolution elevation map from the high-resolution elevation map by employing an optimal model-order reduction based on deep learning.

11. The computer program product of claim 8, wherein the generated low-resolution elevation map provides a first representation of a topography that is physically consistent with a second representation of the topography provided by the high-resolution elevation map.

12. The computer program product of claim 8, wherein the computer readable program code being executed by the one or more processors of the computer system causes the computer system to perform the generating the high-resolution water depth map by employing a Fast Super-Resolution Convolutional Neural Network (FSRCNN) to obtain final high-resolution flood predictions.

13. The computer program product of claim 8, wherein the computer readable program code being executed by the one or more processors of the computer system causes the computer system to perform the following further operations:
generating a temporally interpolated result by applying a temporal interpolation to the low-resolution water depth map; and
inputting the low-resolution elevation map and the temporally interpolated result into the up-sampling neural network, wherein the generating the high-resolution water depth map is based on the inputted low-resolution elevation map and the temporally interpolated result.

14. The computer program product of claim 8, wherein a boundary condition included in the one or more boundary conditions is selected from the group consisting of: an amount of precipitation experienced in a geographic area during a given period of time, a rate of precipitation experienced in the geographic area during the given period of time, a range of temperatures in the geographic area during the given period of time, an amount of wind experienced in the geographic area during the given period of time, other weather conditions experienced in the geographic area during the given period of time, one or more attributes of a surface of land included in the geographic area, and an initial flood state of the geographic area.

15. A computer-implemented method comprising:
generating, by one or more processors and using a down-sampling neural network, a low-resolution elevation map from a high-resolution elevation map;
generating, by the one or more processors and using a partial differential equation (PDE) model, a low-resolution water depth map from the low-resolution elevation map and one or more boundary conditions; and
generating, by the one or more processors and using an up-sampling neural network, a high-resolution water depth map from the low-resolution water depth map,
wherein the down-sampling neural network and the up-sampling neural network are trained by minimizing a loss between the generated high-resolution water depth map and ground truth data generated by the PDE model using the high-resolution elevation map as a direct input and without the PDE model using the low-resolution elevation map.

16. The method of claim 15, further comprising:
determining, by the one or more processors, the loss between the high-resolution water depth map and the ground truth data; and
subsequent to the determining the loss, updating, by the one or more processors, weights of the down-sampling and the up-sampling neural networks through backpropagation.

17. The method of claim 15, wherein the generating the low-resolution elevation map from the high-resolution elevation map includes employing an optimal model-order reduction based on deep learning.

18. The method of claim 15, further comprising providing a first representation of a topography that is physically consistent with a second representation of the topography, wherein the first representation is provided by the generated low-resolution elevation map and the second representation is provided by the high-resolution elevation map.

19. The method of claim 15, wherein the generating the high-resolution water depth map includes employing a Fast Super-Resolution Convolutional Neural Network (FSRCNN) to obtain final high-resolution flood predictions.

20. The method of claim 15, further comprising:
generating, by the one or more processors, a temporally interpolated result by applying a temporal interpolation to the low-resolution water depth map; and
inputting, by the one or more processors, the low-resolution elevation map and the temporally interpolated result into the up-sampling neural network, wherein the generating the high-resolution water depth map is based on the inputted low-resolution elevation map and the temporally interpolated result.
